(19) United States
(12) Patent Application Publication
(10) Pub. No.: US 2013/0202039 A1
(43) Pub. Date: Aug. 8, 2013

(54) METHOD AND DEVICE FOR ENCODING/DECODING IMAGE USING EXTENDED SKIP MODE

(71) Applicants: Jinhan Song, Seoul (KR); Jeongyeon Lim, Gyeonggi-do (KR); Yonggoo Kim, Seoul (KR); Yoonsik Choe, Gyeonggi-do (KR); Yung Ho Choi, Gyeonggi-Do (KR); Sungjei Kim, Seoul (KR)

(72) Inventors: Jinhan Song, Seoul (KR); Jeongyeon Lim, Gyeonggi-do (KR); Yonggoo Kim, Seoul (KR); Yoonsik Choe, Gyeonggi-do (KR); Yung Ho Choi, Gyeonggi-Do (KR); Sungjei Kim, Seoul (KR)

(73) Assignee: SK TELECOM CO., LTD., Seoul (KR)

(21) Appl. No.: 13/811,602

(22) PCT Filed: Jun. 21, 2011
(86) PCT No.: PCT/KR2011/004521

§ 371 Date: Apr. 23, 2013

(30) Foreign Application Priority Data
Jul. 22, 2010 (KR) 10-2010-0070755

(51) Int. Cl. H04N 7/26

(52) U.S. Cl. CPC H04N 19/0069
USPC 375/240.15; 375/240.16

(57) ABSTRACT

A method and apparatus for encoding/decoding an image by using an extended skip mode are provided. The method includes setting a backward reference block motion vector with respect to an adjacent block of a current block as a predictive motion vector of the current block or determining a predictive motion vector from a forward reference block motion vector with respect to a block located in a backward reference picture at the same position as the current block, performing motion compensation by using the predictive motion vector, and setting a prediction mode when the motion compensation results in satisfaction of an optimal skip condition.

### TECHNICAL FIELD

The present disclosure in one or more embodiments relates to a method and apparatus for encoding/decoding an image by using an extended skip mode. More particularly, the present disclosure relates to a method and apparatus for encoding/decoding an image by using an extended skip mode, which improves compression efficiency by effectively removing the redundancy between a current block and reference image data by making a unidirectional skip mode available for application by using previously decoded reference image data when performing block-based motion prediction in a video data compressing apparatus, thus further improving a video data compression performance and providing a superior reconstructed picture quality at the same bitrate.

### BACKGROUND

The statements in this section merely provide background information related to the present disclosure and may not constitute prior art.

In a video data compression apparatus, the conventional H.264/AVC defines a skip mode as one that does not transmit any data (quantized transform coefficient, motion vector, or the like) other than mode information. In the H.264/AVC, skip modes may be classified into skip modes in P slices and in B slices.

The skip mode in a P slice uses a median of motion vectors of adjacent blocks of a current block E to select a reference frame closest to a reference frame buffer L0 (List 0) and perform motion compensation. A block determined by the skip mode can provide a very high compression performance because it does not transmit a motion vector and a residual signal.

The skip mode in a B slice may occur in two cases according to a DIRECT prediction mode. When the DIRECT mode is a temporal DIRECT prediction mode, a motion vector of a current block is predicted by using a motion vector of a block co-located with the current block in a reference frame of a List 1 (L1) that is closest to a current B slice (Current B) to be encoded. Motion compensation of the current block is performed by a weighted sum of two blocks indicated by the thus generated two predictive motion vectors, and likewise additional information about a residual signal or a motion vector is not transmitted.

When the DIRECT mode is a spatial DIRECT prediction mode, a motion vector of a current block E is predicted by using L0 and L1 motion vectors of adjacent blocks of the current block E like the skip mode in the P slice. Motion compensation of the current block is performed by a weighted sum of blocks indicated by the two motion vectors, and an encoder does not transmit additional information other than motion information.

Unlike the skip mode of the P slice, since the skip mode of the B slice may have temporally forward/backward reference frames, both the temporal and spatial direct prediction modes generate a motion block most similar to a current block with reference to two motion vectors.

However, as in the case where a scene changes or a camera moves abruptly where a correlation between two reference blocks is reduced which makes it inadequate to approximate a current block by a weighted sum, the accuracy of motion compensation through the weighted sum may be reduced.

### DISCLOSURE

### Technical Problem

Therefore, to solve the above-mentioned problems, embodiments of the present disclosure seek to improve compression efficiency by effectively removing the redundancy between a current block and reference image data by making a unidirectional skip mode available for application by using previously decoded reference image data when performing block-based motion prediction in a video data compressing apparatus, thus further improving a video data compression performance and providing a superior reconstructed picture quality at the same bitrate.

### Summary

One embodiment of the present disclosure provides an apparatus for encoding/decoding an image, including: an image encoder for setting a backward reference block motion vector with respect to an adjacent block of a current block as a predictive motion vector of the current block or determining a predictive motion vector from a forward reference block motion vector with respect to a block located in a backward reference picture at the same position as the current block, performing motion compensation by using the predictive motion vector, setting a prediction mode when the motion compensation results in satisfaction of an optimal skip condition, and encoding the prediction mode; and an image decoder for decoding a prediction mode by decoding encoded data, and generating a predicted block by predicting a current block responsive if the prediction mode is a forward temporal extended skip mode, by using a forward reference block motion vector in the same direction as a motion vector of a forward reference block with respect to a block located in a backward reference picture at the same position as the current block; if the prediction mode is a backward temporal extended skip mode, by using a backward reference block motion vector in the opposite direction to the motion vector of the forward reference block of the block located in the backward reference picture at the same position as the current block; and if the prediction mode is a backward spatial extended skip mode, by using a backward reference block motion vector with respect to one or more adjacent blocks of the current block.

Another embodiment of the present disclosure provides an apparatus for encoding an image, including: a mode determiner for referring to an anchor block representing a block located in a backward reference picture at the same position as a current block, setting a forward reference block motion vector in the same direction as a motion vector of a forward reference block with respect to the anchor block, as a predictive motion vector, performing motion compensation by using the predictive motion vector, and setting a prediction mode as a forward temporal extended skip mode when the motion compensation results in satisfaction of an optimal skip condition; and an encoder for encoding the prediction mode.

Yet another embodiment of the present disclosure provides an apparatus for encoding an image, including: a mode determiner for referring to an anchor block representing a block located in a backward reference picture at the same position as a current block, setting a backward reference block motion vector in the opposite direction to a forward reference block motion vector with respect to the anchor block, as a predictive motion vector, performing motion compensation by using the predictive motion vector, and setting a prediction mode as a backward temporal extended skip mode when the motion compensation results in satisfaction of an optimal skip condition; and an encoder for encoding the prediction mode.

Yet another embodiment of the present disclosure provides an apparatus for encoding an image, including: a mode determiner for determining a predictive motion vector of a current block from a backward reference block motion vector with respect to one or more adjacent blocks of the current block, performing motion compensation by using the predictive motion vector, and setting a prediction mode as a backward spatial extended skip mode when the motion compensation results in satisfaction of an optimal skip condition; and an encoder for encoding the prediction mode.

Yet another embodiment of the present disclosure provides an apparatus for decoding an image, including: a decoder for decoding a prediction mode by decoding encoded data; and a predictor, responsive if the prediction mode is a forward temporal extended skip mode, for generating a predicted block by predicting a current block by referring to an anchor block representing a block located in a backward reference picture at the same position as a current block and using a forward reference block motion vector in the same direction as a motion vector of a forward reference block with respect to the anchor block.

Yet another embodiment of the present disclosure provides an apparatus for decoding an image, including: a decoder for decoding a prediction mode by decoding encoded data; and a predictor, responsive if the prediction mode is a backward temporal extended skip mode, for generating a predicted block by predicting a current block by using a backward reference block motion vector in the opposite direction to a forward reference block motion vector with respect to a block located in a backward reference picture at the same position as the current block.

Yet another embodiment of the present disclosure provides an apparatus for decoding an image, including: a decoder for decoding a prediction mode by decoding encoded data; and a predictor for generating a predicted block by predicting a current block by using a motion vector of a backward reference block with respect to one or more adjacent blocks of the current block when the prediction mode is a backward spatial extended skip mode.

Yet another embodiment of the present disclosure provides a method for encoding/decoding an image, including: setting a backward reference block motion vector with respect to an adjacent block of a current block as a predictive motion vector of the current block or determining a predictive motion vector from a forward reference block motion vector with respect to a block located in a backward reference picture as the same position as the current block, performing motion compensation by using the predictive motion vector, setting a prediction mode when the motion compensation results in satisfaction of an optimal skip condition and encoding the prediction mode; and decoding a prediction mode by decoding encoded data, and generating a predicted block by predicting a current block responsive if the prediction mode is a forward temporal extended skip mode, by using a forward reference block motion vector in the same direction as a motion vector of a forward reference block with respect to a block located in a backward reference picture at the same position as the current block; if the prediction mode is a backward temporal extended skip mode, by using a backward reference block motion vector in the opposite direction to the motion vector of the forward reference block of the block located in the backward reference picture at the same position as the current block; and if the prediction mode is a backward spatial extended skip mode, by using a backward reference block motion vector with respect to one or more adjacent blocks of the current block.

Yet another embodiment of the present disclosure provides a method for encoding an image, including: referring to an anchor block representing a block located in a backward reference picture at the same position as a current block, setting a forward reference block motion vector in the same direction as a motion vector of a forward reference block with respect to the anchor block, as a predictive motion vector, performing motion compensation by using the predictive motion vector, and setting a prediction mode as a forward temporal extended skip mode when the motion compensation results in satisfaction of an optimal skip condition; and encoding the prediction mode.

Herein, the block in the backward reference picture may be a block in a reference picture that is closest to the current block among all other backward reference pictures.

Herein, the optimal skip condition may be determined to be satisfied when a rate-distortion cost of the forward temporal extended skip mode is small in consideration of a distortion value and a bit amount that are generated when predicting and encoding a current block for each of inter-prediction mode candidates in all inter-predictable mode sets including the forward temporal extended skip mode.

Yet another embodiment of the present disclosure provides a method for encoding an image, including: referring to an anchor block representing a block located in a backward reference picture at the same position as a current block, setting a backward reference block motion vector in the opposite direction to a forward reference block motion vector with respect to the anchor block, as a predictive motion vector, performing motion compensation by using the predictive motion vector, and setting a prediction mode as a backward temporal extended skip mode when the motion compensation results in satisfaction of an optimal skip condition; and encoding the prediction mode.

Herein, the block in the backward reference picture may be a block in a reference picture that is closest to the current block among all other backward reference pictures.

Herein, the optimal skip condition may be determined to be satisfied when a rate-distortion cost of the backward temporal extended skip mode is small in consideration of a distortion value and a bit amount that are generated when predicting and encoding a current block for each of inter-prediction mode candidates in all inter-predictable mode sets including the backward temporal extended skip mode.

Yet another embodiment of the present disclosure provides a method for encoding an image, including: determining a predictive motion vector of a current block from a backward reference block motion vector with respect to one or more adjacent blocks of the current block, performing motion compensation by using the predictive motion vector, and setting a prediction mode as a backward spatial extended skip mode when the motion compensation results in satisfaction of an optimal skip condition; and encoding the prediction mode.

Herein, the optimal skip condition may be determined to be satisfied when a rate-distortion cost of the backward spatial extended skip mode is small in consideration of a distortion value and a bit amount that are generated when predicting and encoding a current block for each of inter-prediction mode candidates in all inter-predictable mode sets including the backward spatial extended skip mode.

Herein, the backward reference block motion vector may be set as a median of backward reference block motion vectors of the one or more adjacent blocks of the current block.

Yet another embodiment of the present disclosure provides a method for decoding an image, including: decoding a prediction mode by decoding encoded data; and if the prediction mode is a forward temporal extended skip mode, generating a predicted block by predicting a current block by referring to an anchor block representing a block located in a backward reference picture at the same position as a current block and using a forward reference block motion vector in the same direction as a motion vector of a forward reference block with respect to the anchor block.

Yet another embodiment of the present disclosure provides a method for decoding an image, including: decoding a prediction mode by decoding encoded data; and if the prediction mode is a backward temporal extended skip mode, generating a predicted block by predicting a current block by referring to an anchor block representing a block located in a backward reference picture at the same position as a current block and using a backward reference block motion vector in the opposite direction to a motion vector of a forward reference block with respect to the anchor block.

Yet another embodiment of the present disclosure provides a method for decoding an image, including: decoding a prediction mode by decoding encoded data; and generating a predicted block by predicting a current block by using a motion vector of a backward reference block with respect to one or more adjacent blocks of the current block when the prediction mode is a backward spatial extended skip mode.

Herein, the block in the backward reference picture may be a block in a reference picture that is closest to the current block among all other backward reference pictures.

Herein, the backward reference block motion vector may be set as a median of backward reference block motion vectors of the one or more adjacent blocks of the current block.

### Advantageous Effects

As described above, according to the embodiments of the present disclosure, the present disclosure can improve compression efficiency by effectively removing the redundancy between a current block and reference image data by making a unidirectional skip mode available for application by using previously decoded reference image data when performing block-based motion prediction in a video data compressing apparatus, thus making it possible to further improve a video data compression performance and provide a superior reconstructed picture quality at the same bitrate.

### DESCRIPTION OF DRAWINGS

FIG. 1 is a block diagram illustrating a schematic configuration of an image encoding apparatus according to one embodiment of the present disclosure;

FIG. 2 is a diagram illustrating a position relation between a current block and a forward reference frame (L0) and a backward reference frame (L1) of the current block;

FIG. 3 is a diagram illustrating a predictive motion vector in a forward temporal extended skip mode;

FIG. 4 is a diagram illustrating a predictive motion vector in a backward temporal extended skip mode;

FIG. 5 is a diagram illustrating a position relation between a current block and an adjacent block;

FIG. 6 is a block diagram illustrating a schematic configuration of an image decoding apparatus according to one embodiment of the present disclosure;

FIG. 7 is a flow diagram illustrating an image encoding method according to a first embodiment of the present disclosure;

FIG. 8 is a flow diagram illustrating an image encoding method according to a second embodiment of the present disclosure;

FIG. 9 is a flow diagram illustrating an image encoding method according to a third embodiment of the present disclosure; and

FIG. 10 is a flow diagram illustrating an image decoding method according to one embodiment of the present disclosure.

### DETAILED DESCRIPTION

Hereinafter, embodiments of the present disclosure will be described in detail with reference to the accompanying drawings. In the following description, like reference numerals designate like elements although they are shown in different drawings. Further, in the following description of the present embodiments, a detailed description of known functions and configurations incorporated herein will be omitted for the purpose of clarity.

Additionally, in describing the components of the present disclosure, there may be terms used like first, second, A, B, (a), and (b). These are solely for the purpose of differentiating one component from the other but not to imply or suggest the substances, order or sequence of the components. If a component were described as ‘connected’, ‘coupled’, or ‘linked’ to another component, they may mean the components are not only directly ‘connected’, ‘coupled’, or ‘linked’ but also are indirectly ‘connected’, ‘coupled’, or ‘linked’ via a third component.

An image encoding apparatus (video encoding apparatus) and an image decoding apparatus (video decoding apparatus) to be described below may be a user terminal such as a personal computer (PC), a notebook or laptop computer, a personal digital assistant (PDA), a portable multimedia player (PMP), a PlayStation Portable (PSP), or a wireless communication terminal, or a smart phone, or a server terminal such as an application server or a service server, and may represent a variety of apparatuses including, for example, a communication device such as a communication modem for performing communications between various devices or wired/wireless communication networks, a memory for storing various programs and data for encoding or decoding an image or performing inter/intra prediction for encoding or decoding, and a microprocessor for executing the programs to perform operations and controls.

In addition, the image encoded into a bitstream by the image encoding apparatus may be transmitted in real time or non-real time to the image decoding apparatus for decoding the same where it is reconstructed and reproduced into the image after being transmitted through a wired/wireless communication network such as the Internet, a short range wireless communication network, a wireless LAN network, a WiBro (Wireless Broadband) network (also known as WiMax network), or a mobile communication network, or through various communication interfaces such as a cable and a USB (universal serial bus).

In general, a video image includes a series of pictures, and each picture may be divided into predetermined regions such as frames or blocks. When an image is divided into blocks, the blocks may be classified into an intra block and an inter block according to encoding methods. The intra block is a block encoded by intra prediction encoding. The intra prediction encoding is a method that generates a predicted block by predicting a pixel of a current block by using pixels of blocks that are previously encoded/decoded/reconstructed in a current picture that is currently encoded, and encodes a differential value thereof with respect to the pixel of the current block. The inter block is a block encoded by inter prediction encoding. The inter prediction encoding is a method that generates a predicted block by predicting a current block in a current picture with reference to one or more previous pictures or next pictures, and encodes a differential value thereof from the current block. Herein, a frame referred to in order to encode/decode a current picture will be called a reference frame, and a picture including the reference frame will be called a reference picture.

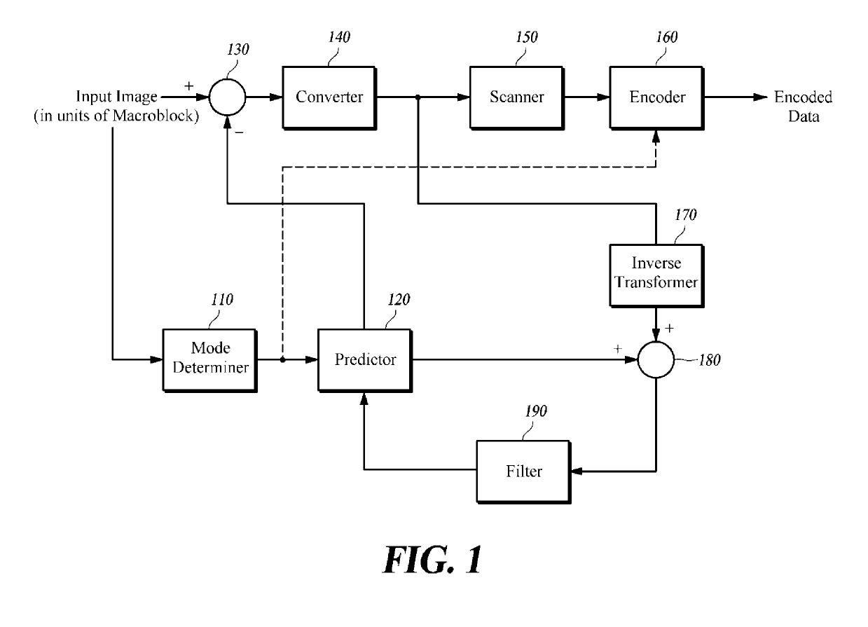

FIG. 1 is a block diagram illustrating a schematic configuration of an image encoding apparatus according to one embodiment of the present disclosure.

An image encoding apparatus 100 according to one embodiment of the present disclosure may include a mode determiner 110, a predictor 120, a subtracter 130, a transformer 140, a scanner 150, an encoder 160, an inverse transformer 170, an adder 180, and a filter 190.

An input image to be encoded may be inputted in units of a block, and the block may be a macroblock. In one embodiment of the present disclosure, a macroblock may be various types such as M×N, wherein M and N may be natural numbers having a value of 2ⁿ (n: an integer greater than or equal to 1). In addition, different types of blocks may be used for respective frames to be encoded, and information thereon, that is, information about a block type may be encoded in each frame so that an image decoding apparatus can determine a block type of a frame to be decoded when decoding encoded data.

To this end, the image encoding apparatus 100 may further include a block type determiner (not illustrated) for determining a block type, encoding information about the block type, and including the result in encoded data.

The mode determiner 110 may select and set one prediction mode among a prediction mode set. The prediction mode set used in the image encoding apparatus 100 may include one or more of a forward temporal extended skip mode, a backward temporal extended skip mode, and a backward spatial extended skip mode.

The encoder 160 encodes the prediction mode determined by the mode determiner 110. Data about the prediction mode encoded may be transmitted to an image decoder.

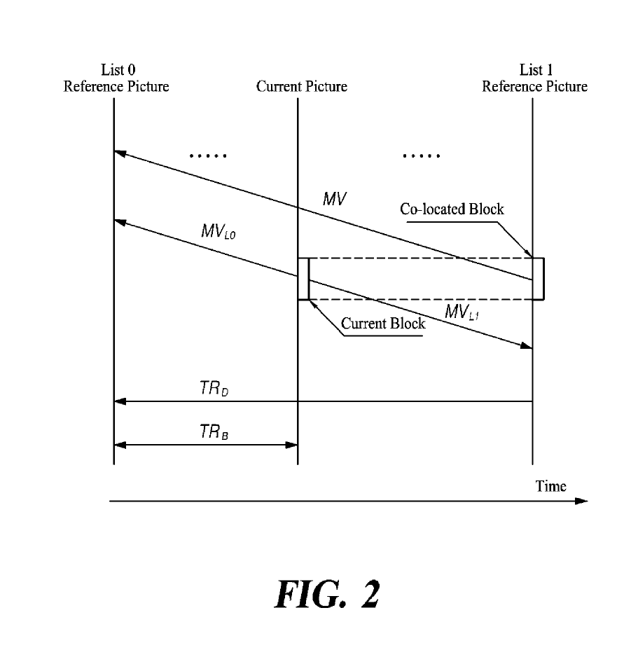

FIG. 2 is a diagram illustrating a position relation between a current block and a forward reference frame (L0) and a backward reference frame (L1) of the current block.

When a forward temporal extended skip mode is included in a prediction mode set used in the image encoding apparatus 100, the mode determiner 110 refers to a block (hereinafter referred to as anchor block) located in a backward reference picture (or backward reference frame) at the same position as a current block, sets a forward reference block motion vector in the same direction as a motion vector MV of a forward reference block with respect to the anchor block, as a predictive motion vector, performs motion compensation by using the predictive motion vector, and sets a prediction mode as a forward temporal extended skip mode when the motion compensation results in satisfaction of an optimal skip condition.

Herein, the optimal skip condition is determined to be satisfied when a rate-distortion cost of the forward temporal extended skip mode is small in consideration of a distortion value and a bit amount that are generated when predicting and encoding a current block for each of inter-prediction mode candidates in all inter-predictable mode sets. In this case, the prediction mode is set as the forward temporal extended skip mode.

As illustrated in FIG. 2, the mode determiner 110 sets a forward motion vector MV_{L0} (i.e., a forward reference block motion vector) having the same direction as a forward reference block motion vector MV of a co-located block being a block in a backward reference frame (L1 or List 1) having the same position as a position in a current frame of a current block, as a predictive motion vector. The mode determiner 110 performs motion compensation by using the predictive motion vector, and a prediction mode of the current block as a forward temporal extended skip mode when the motion compensation results in satisfaction of an optimal skip condition.

If a backward temporal extended skip mode is included in a prediction mode set used in the image encoding apparatus 100, the mode determiner 110 refers to a block (hereinafter referred to as anchor block) located in a backward reference frame at the same position as a current block, and sets a backward motion vector MV_{L1} (i.e., a backward reference block motion vector) in the opposite direction to a motion vector MV of a forward reference block with respect to the anchor block, as a predictive motion vector. The mode determiner 110 performs motion compensation by using the predictive motion vector, and sets a prediction mode as a backward temporal extended skip mode when the motion compensation results in satisfaction of an optimal skip condition.

Herein, the optimal skip condition is determined to be satisfied if a rate-distortion cost of the backward temporal extended skip mode is small in consideration of a distortion value and a bit amount that are generated when predicting and encoding a current block for each of inter-prediction mode candidates in all inter-predictable mode sets including the backward temporal extended skip mode. In this case, the prediction mode is set as the backward temporal extended skip mode.

The forward motion vector MV_{L0} and the backward motion vector MV_{L1} of the current block may be obtained from Equation 1.

$${MV}_{L 0} = \frac{{TR}_{B}}{{TR}_{D}} \times MV \\ {MV}_{L 1} = \frac{( {TR}_{B} - {TR}_{D} )}{{TR}_{D}} \times MV \qquad Equation 1$$

Herein, TR_{B} denotes a time interval between a reference picture L0 and a current picture being a picture to be currently encoded, and TR_{D} denotes a time interval between a reference picture L0 and a backward reference picture.

The block in the backward reference frame may be a block in a reference frame that is closest to a current picture among all other backward reference frames.

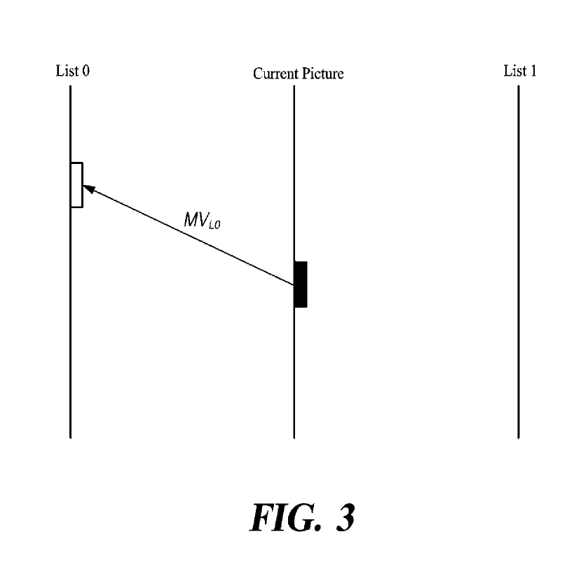

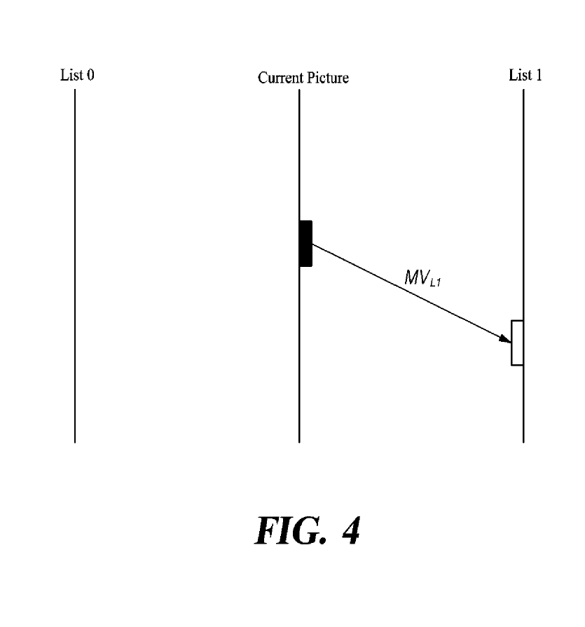

FIG. 3 is a diagram illustrating a predictive motion vector in a forward temporal extended skip mode, and FIG. 4 is a diagram illustrating a predictive motion vector in a backward temporal extended skip mode.

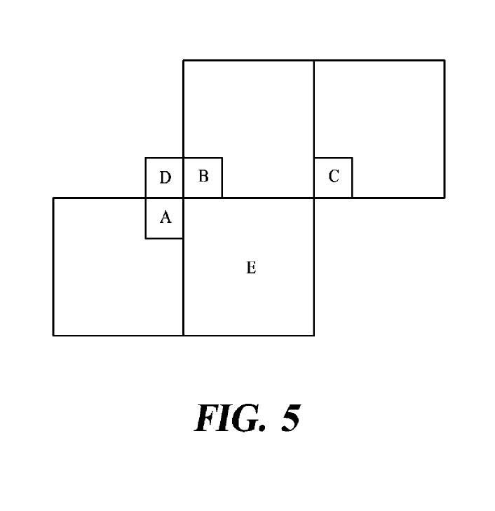

FIG. 5 is a diagram illustrating a position relation between a current block and an adjacent block.

When a backward spatial extended skip mode is included in a prediction mode set used in the image encoding apparatus 100, the mode determiner 110 determines a predictive motion vector of a current block E from a backward motion vector of an adjacent block (e.g., A (left block A), B (upper block), or C (upper right block)) of the current block E, performs motion compensation by using the predictive motion vector, and sets a prediction mode as a backward spatial extended skip mode when the motion compensation results in satisfaction of an optimal skip condition. Herein, the adjacent block of the current block E is not limited to A, B, or C, but may be A, B, C, or D (upper left block).

Herein, the optimal skip condition is determined to be satisfied if a rate-distortion cost of the backward spatial extended skip mode is small in consideration of a distortion value and a bit amount that are generated when predicting and encoding a current block for each of inter-prediction mode candidates in all inter-predictable mode sets including the backward spatial extended skip mode. In this case, the prediction mode is set as the backward spatial extended skip mode.

The predictive motion vector may be set as a median of backward motion vectors of adjacent blocks (A, B, and C) of a current block, but the present disclosure is not limited thereto. The adjacent blocks may be determined in various ways, and the predictive motion vector may be calculated from the backward motion vector of the adjacent block in various ways. In addition, a horizontal component of the predictive motion vector may be calculated from a horizontal component of a backward motion vector of the adjacent block (A, B, or C), and a vertical component of the predictive motion vector may be calculated from a vertical component of a backward motion vector of the adjacent block (A, B, or C).

The predictor 120 generates a predicted block by predicting the current block. Specifically, the predictor 120 predicts a pixel value of each pixel of the current block to be encoded in an image, and generates a predicted block having a predicted pixel value of each pixel. Herein, the predictor 120 may predict the current block by using intra prediction or inter prediction. However, when the prediction mode is one of the forward temporal extended skip mode, the backward temporal extended skip mode, and the backward spatial extended skip mode, the predictor 120 does not generate a predicted block.

The subtracter 130 generates a residual block by subtracting the predicted block from the current block. Specifically, the subtracter 130 generates a residual block with a residual signal by calculating a difference between the pixel value of each pixel of the current block to be encoded and the predicted pixel value of each pixel of the predicted block predicted by the predictor 120.

When the transformer 140 transforms the residual block, a transform process may be included in a quantization process. In this case, the transform process is not completed until the quantization process is completed. Herein, a technique to transform a spatial-domain image signal into a frequency-domain signal, such as Hadamard Transform or Discrete Cosine Transform Based Integer Transform (hereinafter simply referred to as integer transform), may be used as the transform method, and various quantization techniques such as Dead Zone Uniform Threshold Quantization (DZUTQ) and Quantization Weighted Matrix may be used as the quantization method.

The scanner 150 generates a coefficient string by scanning coefficients of a color-space predicted block generated by the transformer 140. Herein, the scanning method considers the characteristics of a transform technique, a quantization technique, and a block (macroblock or subblock), and the scanning sequence may be determined so that the scanned coefficient string has the minimum strength. Although FIG. 1 illustrates that the scanner 150 is implemented separately from the encoder 160, the scanner 150 may be omitted and its function may be integrated into the encoder 160.

An entropy encoding technology may be used as the encoding technology, although other unlimited encoding technologies may be used as the encoding technology. In addition, the encoder 160 may include not only the prediction mode, but also a variety of information necessary to decode an encoded bitstream, in the encoded data. Herein, the variety of information necessary to decode the encoded bitstream may be a variety of information such as information about a block type.

The inverse transformer 170 reconstructs the residual block by inverse-transforming a transformed residual block generated by the transformer 140. If quantization is also performed by the transformer 140, the inverse transformer 170 may perform inverse quantization and inverse transform by inversely performing the transform process and the quantization process performed by the transformer 140.

The adder 180 reconstructs the current block by adding the predicted block generated by the predictor 120 and the residual block generated by the inverse transformer 170.

The filter 190 filters the current block reconstructed by the adder 180. The filter 190 reduces a blocking effect that is generated at a block boundary or a transform boundary by transform/quantization of an image in units of a block.

However, when the prediction mode is one of the forward temporal extended skip mode, the backward temporal extended skip mode, and the backward spatial extended skip mode, the subtracter 130, the transformer 140, the scanner 150, the inverse transformer 170, the adder 180, and the filter 190 may not operate.

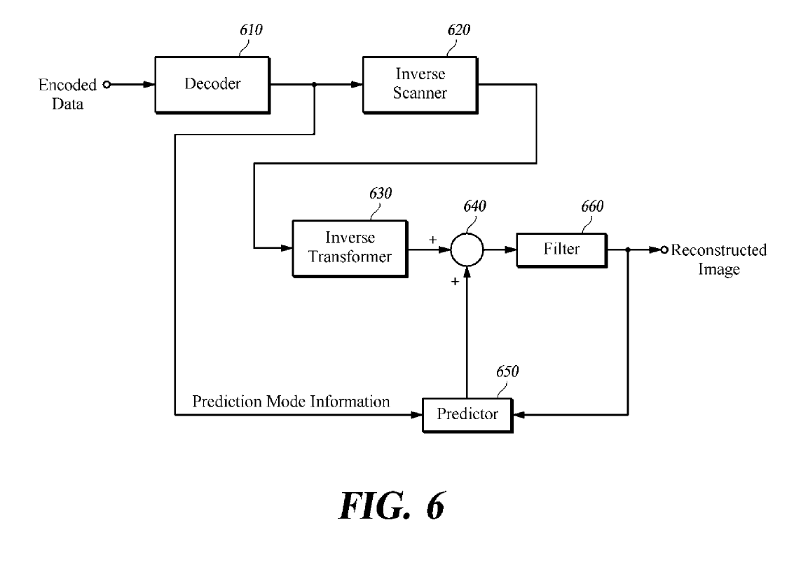

FIG. 6 is a block diagram illustrating a schematic configuration of an image decoding apparatus according to one embodiment of the present disclosure.

An image decoding apparatus 600 according to one embodiment of the present disclosure may include a decoder 610, an inverse scanner 620, an inverse transformer 630, an adder 640, a predictor 650, and a filter 660. Herein, the inverse scanner 620 and the filter 660 are not necessarily included but may be omitted selectively according to implementation modes. When the inverse scanner 620 is omitted, a function of the inverse scanner 620 may be integrated into the decoder 610.

The decoder 610 decodes a prediction mode by decoding encoded data. When a function of the scanner 150 is integrated into the encoder 160 in the image encoding apparatus 100, the inverse scanner 620 is omitted from the image decoding apparatus 600 and its function is integrated into the decoder 610. Therefore, the decoder 610 may reconstruct a transformed residual block by inverse-scanning the encoded data.

In addition, the decoder 610 may decode the encoded data to decode or extract not only a color-space predicted block but also information necessary for decoding. The information necessary for decoding refers to information necessary to decode an encoded bitstream in the encoded data, and may include information about a block type, information about an intra prediction mode (if the prediction mode is an intra prediction mode), information about a motion vector (if the prediction mode is an inter prediction mode), information about a transform/quantization type, and various other information.

The information about a block type may be input and transmitted to the inverse transformer 630 and the predictor 650. The information about a transform type (or a transform/quantization type) may be transmitted to the inverse transformer 630. Information necessary for prediction such as the information about a prediction mode and the information the information about a motion vector may be transmitted to the predictor 650.

When the decoder 610 reconstructs and transmits a transform coefficient string, the inverse scanner 620 reconstructs a predicted block by inverse-scanning the transform coefficient string.

The inverse scanner 620 generates a color-space predicted block by inverse-scanning an extracted coefficient string by various inverse scanning methods such as inverse zigzag scanning. Herein, information about a transform size is obtained from the decoder 610, and an inverse scanning method corresponding to the information is used to generate a residual block.

The inverse transformer 630 reconstructs the residual block by inverse-transforming a reconstructed transformed residual block. In this case, the inverse transformer 630 may inverse-transform the transformed residual block according to a transform type. Herein, since a method of inverse-transforming the transformed residual block by the inverse transformer 630 according to the transform type is identical or similar to the inverse of the transform process by the transformer 140 of the image encoding apparatus 100 according to the transform type, a detailed description of the inverse-transform method will be omitted.

The predictor 650 generates the predicted block by predicting the current block.

The predictor 650 may generate the predicted block by determining a size and type of the current block according to a block type identified by information about a block type and predicting the current block by using a motion vector or an intra prediction mode identified by information necessary for prediction. Herein, the predictor 650 may generate the predicted block by combining predicted subblocks generated by dividing the current block into subblocks and predicting the subblocks, in an identical or similar manner to that of the predictor 120 of the image encoding apparatus 100.

The adder 640 reconstructs the current block by adding the residual block reconstructed by the inverse transformer 630 and the predicted block generated by the predictor 650.

The filter 660 filters the current block reconstructed by the adder 640. The current block reconstructed and filtered may be accumulated in units of a picture and stored as a reference picture in a memory (not illustrated), and it may be used by the predictor 650 to predict a next block or a next picture.

Since a filtering method of the filter 660 is identical or similar to the deblocking filtering process performed by the filter 190 of the image encoding apparatus 100, a detailed description of the filtering method will be omitted.

However, when the prediction mode is one of the forward temporal extended skip mode, the backward temporal extended skip mode, and the backward spatial extended skip mode, the inverse scanner 620, the inverse transformer 630, the adder 640, and the filter 660 may not operate.

When the decoded prediction mode is the forward temporal extended skip mode, the predictor 650 generates a predicted block by predicting a current block by using a forward motion vector in the same direction as a forward reference block motion vector with respect to a block located in a backward reference frame at the same position as the current block. Specifically, the predictor 650 obtains a forward motion vector MV_{L0} of the current block as Equation 1, and generates a block (see FIG. 3) indicated by the forward motion vector MV_{L0} as the predicted block. Since information about a pixel of the residual block is not transmitted from the image encoding apparatus 100, the generated predicted block is a reconstructed block.

When the decoded prediction mode is the backward temporal extended skip mode, the predictor 650 generates a predicted block by predicting a current block by using a backward motion vector in the opposite direction to a forward reference block motion vector with respect to a block located in a backward reference frame at the same position as the current block. Specifically, the predictor 650 obtains a backward motion vector MV_{L1} of the current block as Equation 1, and generates a block (see FIG. 4) indicated by the backward motion vector MV_{L1} as the predicted block. Since information about a pixel of the residual block is not transmitted from the image encoding apparatus 100, the generated predicted block is a reconstructed block.

Herein, the block in the backward reference frame may be a block in a reference frame that is closest to the current block among all other backward reference frames.

When the decoded prediction mode is the backward spatial extended skip mode, the predictor 650 generates the predicted block by predicting the current block by using a backward motion vector of an adjacent block of the current block. A predictive motion vector may be set as a median of backward motion vectors of adjacent blocks (A, B, and C) of the current block as illustrated in FIG. 5, but the present disclosure is not limited thereto. The adjacent blocks may be determined in various ways, and the predictive motion vector may be calculated from the backward motion vector of the adjacent block in various ways. In addition, a horizontal component of the predictive motion vector may be calculated from a horizontal component of a backward motion vector of the adjacent block (A, B, or C), and a vertical component of the predictive motion vector may be calculated from a vertical component of a backward motion vector of the adjacent block (A, B, or C). Since information about a pixel of the residual block is not transmitted from the image encoding apparatus 100, the generated predicted block is a reconstructed block.

Herein, the backward motion vector may be set as a median of backward motion vectors of adjacent blocks of the current block.

An image encoding/decoding apparatus according to one embodiment of the present disclosure may be implemented by combining the image encoding apparatus 100 of FIG. 1 and the image decoding apparatus 600 of FIG. 6.

The image encoding/decoding apparatus according to one embodiment of the present disclosure includes: an image encoder (which may be implemented by using the image encoding apparatus 100) for setting a backward motion vector with respect to an adjacent block of a current block as a predictive motion vector of the current block or determining a predictive motion vector from a forward reference block motion vector with respect to a block located in a backward reference frame at the same position as the current block, performing motion compensation by using the predictive motion vector, setting a prediction mode when the motion compensation results in satisfaction of an optimal skip condition, and encoding the prediction mode; and an image decoder (which may be implemented by using the image decoding apparatus 600) for decoding a prediction mode by decoding encoded data, and generating a predicted block by predicting a current block, responsive if the prediction mode is a forward temporal extended skip mode, by using a forward motion vector in the same direction as a motion vector of a forward reference block with respect to a block located in a backward reference frame at the same position as the current block; if the prediction mode is a backward temporal extended skip mode, by using a backward motion vector in the opposite direction to the motion vector of the forward reference block of the block located in the backward reference frame at the same position as the current block; and if the prediction mode is a backward spatial extended skip mode, by using a backward motion vector with respect to one or more adjacent blocks of the current block.

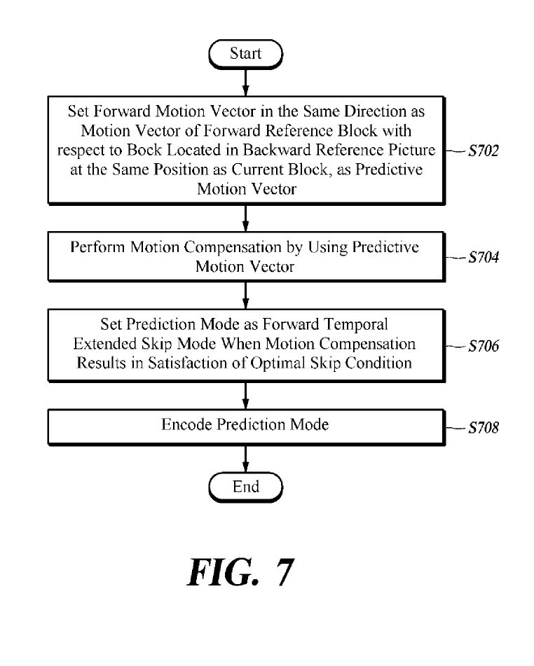

FIG. 7 is a flow diagram illustrating an image encoding method according to a first embodiment of the present disclosure.

The image encoding method according to the first embodiment of the present disclosure may include: referring to a block (anchor block) located in a backward reference frame at the same position as a current block and setting a forward motion vector in the same direction as a motion vector of a forward reference block with respect to the anchor block, as a predictive motion vector (S702), performing motion compensation by using the predictive motion vector (S704), setting a prediction mode as a forward temporal extended skip mode when the motion compensation results in satisfaction of an optimal skip condition (step S706), and encoding the prediction mode (S708).

Herein, the block in the backward reference frame may be a block in a reference frame that is closest to the current block among all other backward reference frames.

Herein, the optimal skip condition may be determined to be satisfied when a rate-distortion cost of the forward temporal extended skip mode is small in consideration of a distortion value and a bit amount that are generated when predicting and encoding a current block for each of inter-prediction mode candidates in all inter-predictable mode sets including the forward temporal extended skip mode.

Since an operation of the image encoding method according to the first embodiment of present disclosure has already been described in the description of the image encoding apparatus according to one embodiment of the present disclosure, a detailed description thereof will be omitted herein.

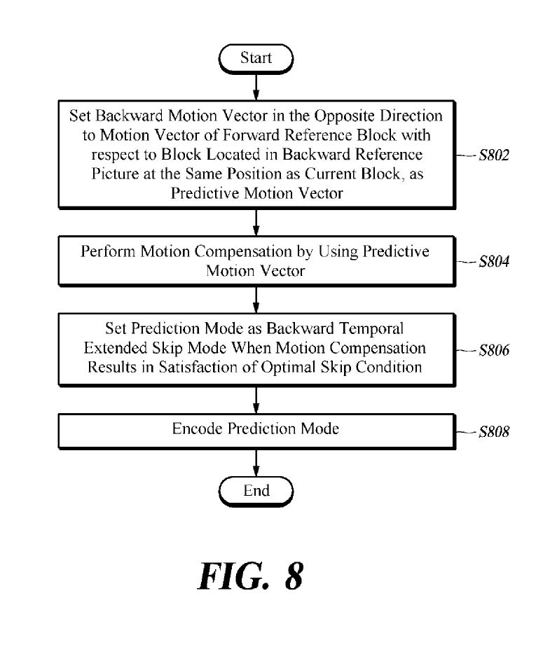

FIG. 8 is a flow diagram illustrating an image encoding method according to a second embodiment of the present disclosure.

The image encoding method according to the second embodiment of the present disclosure may include: referring to a block (anchor block) located in a backward reference frame at the same position as a current block and setting a backward motion vector in the opposite direction to a motion vector of a forward reference block with respect to the anchor block, as a predictive motion vector (S802), performing motion compensation by using the predictive motion vector (S804), setting a prediction mode as a backward temporal extended skip mode when the motion compensation results in satisfaction of an optimal skip condition (step S806), and encoding the prediction mode (S808).

Herein, the block in the backward reference frame may be a block in a reference frame that is closest to the current block among all other backward reference frames.

Herein, the optimal skip condition may be determined to be satisfied when a rate-distortion cost of the backward temporal extended skip mode is small in consideration of a distortion value and a bit amount that are generated when predicting and encoding a current block for each of inter-prediction mode candidates in all inter-predictable mode sets including the backward temporal extended skip mode.

Since an operation of the image encoding method according to the second embodiment of present disclosure has already been described in the description of the image encoding apparatus according to one embodiment of the present disclosure, a detailed description thereof will be omitted herein.

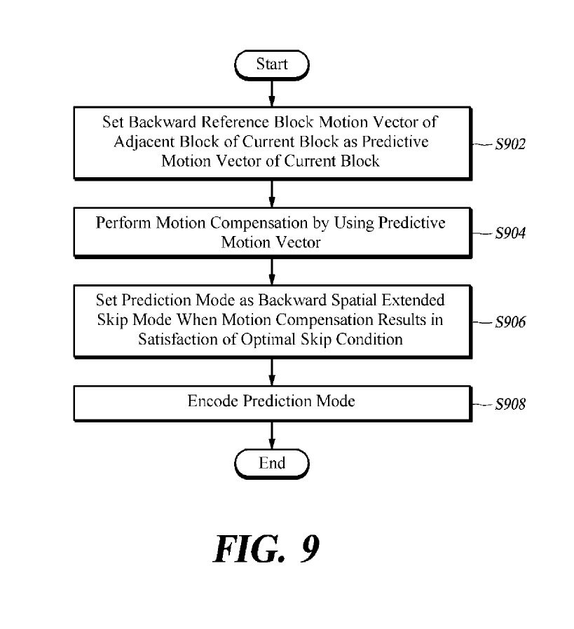

FIG. 9 is a flow diagram illustrating an image encoding method according to a third embodiment of the present disclosure.

The image encoding method according to the third embodiment of the present disclosure may include: setting a backward motion vector with respect to one or more adjacent blocks of a current block as a predictive motion vector of the current block (S902), performing motion compensation by using the predictive motion vector (S904), setting a prediction mode as a backward spatial extended skip mode when the motion compensation results in satisfaction of an optimal skip condition (step S906), and encoding the prediction mode (S908).

Herein, the optimal skip condition may be determined to be satisfied when a rate-distortion cost of the backward spatial extended skip mode is small in consideration of a distortion value and a bit amount that are generated when predicting and encoding a current block for each of inter-prediction mode candidates in all inter-predictable mode sets including the backward spatial extended skip mode.

Herein, the backward motion vector may be set as a median of backward motion vectors of the one or more adjacent blocks of the current block.

Since an operation of the image encoding method according to the third embodiment of present disclosure has already been described in the description of the image encoding apparatus according to one embodiment of the present disclosure, a detailed description thereof will be omitted herein.

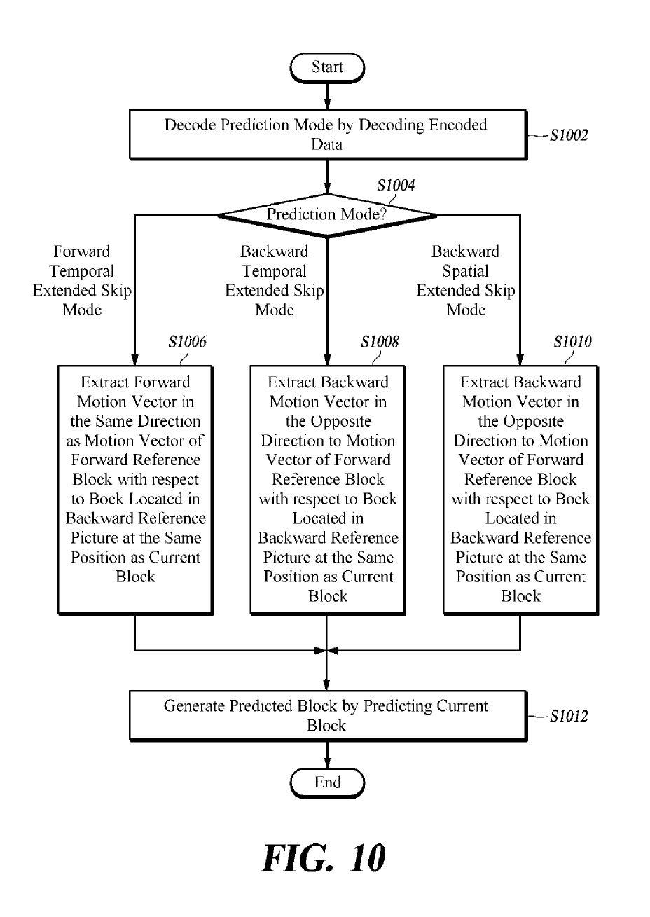

FIG. 10 is a flow diagram illustrating an image decoding method according to one embodiment of the present disclosure.

The image decoding method according to one embodiment of the present disclosure may include: decoding a prediction mode by decoding encoded data (S1002); determining the prediction mode (S1004); generating a predicted block by predicting a current block by using a forward motion vector in the same direction as a forward reference block motion vector with respect to a block located in a backward reference frame at the same position as the current block, when the prediction mode is a forward temporal extended skip mode (S1006); generating a predicted block by predicting a current block by using a backward motion vector in the opposite direction to a forward reference block motion vector with respect to a block located in a backward reference frame at the same position as the current block, when the prediction mode is a backward temporal extended skip mode (S1008); generating a predicted block by predicting a current block by using a backward motion vector with respect to one or more adjacent blocks of the current block when the prediction mode is a backward spatial extended skip mode (S1010); and generating a predicted block by predicting a current block (S1012).

Herein, the block in the backward reference frame may be a block in a reference frame that is closest to the current block among all other backward reference frames.

Herein, the backward motion vector may be set as a median of backward motion vectors of the one or more adjacent blocks of the current block.

Steps S1006, S1008 and S1010 may be included in one embodiment. However, according to embodiments, when the forward temporal extended skip mode is not included in a prediction mode that can be set in the image decoding method according to one embodiment of the present disclosure, step S1006 may be omitted; when the backward temporal extended skip mode is not included in the prediction mode, step S1008 may be omitted; and when the backward spatial extended skip mode is not included in the prediction mode, step S1010 may be omitted.

Since an operation of the image decoding method according to one embodiment of present disclosure has already been described in the description of the image decoding apparatus according to one embodiment of the present disclosure, a detailed description thereof will be omitted herein.

An image encoding/decoding method according to one embodiment of the present disclosure may be implemented by combining the image encoding method according to the first to third embodiments of the present disclosure illustrated in FIGS. 7 to 9 and the image decoding method according to one embodiment of the present disclosure illustrated in FIG. 10.

The image encoding/decoding method according to one embodiment of the present disclosure may include: setting a backward motion vector with respect to an adjacent block of a current block as a predictive motion vector of the current block or determining a predictive motion vector from a forward reference block motion vector with respect to a block located in a backward reference frame at the same position as the current block, performing motion compensation by using the predictive motion vector, setting a prediction mode when the motion compensation results in satisfaction of an optimal skip condition, and encoding the prediction mode; and decoding a prediction mode by decoding encoded data, and generating a predicted block by predicting a current block, responsive if the prediction mode is a forward temporal extended skip mode, by using a forward motion vector in the same direction as a motion vector of a forward reference block with respect to a block located in a backward reference frame at the same position as the current block; if the prediction mode is a backward temporal extended skip mode, by using a backward motion vector in the opposite direction to the motion vector of the forward reference block of the block located in the backward reference frame at the same position as the current block; and if the prediction mode is a backward spatial extended skip mode, by using a backward motion vector with respect to one or more adjacent blocks of the current block.

As described above, according to one embodiment of the present disclosure, in order to effectively encode a motion vector of a current block, a context of the motion vector is generated based on a motion vector correlation of an adjacent block, and a motion vector candidate is provided adaptively according to the condition of an adjacent block. Accordingly, the encoding performance of the motion vector of the current block can be greatly improved, so that the encoding performance of a video compression apparatus or the picture quality of a reconstructed image can be improved.

In the description above, although all of the components of the embodiments of the present disclosure may have been explained as assembled or operatively connected as a unit, the present disclosure is not intended to limit itself to such embodiments. Rather, within the objective scope of the present disclosure, the respective components may be selectively and operatively combined in any numbers. Every one of the components may be also implemented by itself in hardware while the respective ones can be combined in part or as a whole selectively and implemented in a computer program having program modules for executing functions of the hardware equivalents. Codes or code segments to constitute such a program may be easily deduced by a person skilled in the art. The computer program may be stored in computer readable media, which in operation can realize the aspects of the present disclosure. As the computer readable media, the candidates include magnetic recording media, optical recording media, and carrier wave media.

In addition, terms like ‘include’, ‘comprise’, and ‘have’ should be interpreted in default as inclusive or open rather than exclusive or closed unless expressly defined to the contrary. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

Although exemplary embodiments of the present disclosure have been described for illustrative purposes, those skilled in the art will appreciate that various modifications, additions and substitutions are possible, without departing from essential characteristics of the disclosure. Therefore, exemplary embodiments of the present disclosure have not been described for limiting purposes. Accordingly, the scope of the disclosure is not to be limited by the above embodiments but by the claims and the equivalents thereof.

### INDUSTRIAL APPLICABILITY

As described above, according to the embodiments of the present disclosure, the present disclosure has high industrial applicability because it improves compression efficiency by effectively removing the redundancy between a current block and reference image data by making a unidirectional skip mode available for application by using previously decoded reference image data when performing block-based motion prediction in a video data compressing apparatus, thus further improving a video data compression performance and providing a superior reconstructed picture quality at the same bitrate.

### CROSS-REFERENCE TO RELATED APPLICATION

If applicable, this application claims priority under 35 U.S.C. §119(a) of Patent Application No. 10-2010-0070755, filed on Jul. 22, 2010 in Korea, the entire content of which is incorporated herein by reference. In addition, this non-provisional application claims priority in countries, other than the U.S., with the same reason based on the Korean Patent Application, the entire content of which is hereby incorporated by reference.

1. (canceled)

2. An apparatus for encoding an image, comprising:
a mode determiner for referring to an anchor block representing a block located in a backward reference picture at the same position as a current block, setting a forward reference block motion vector in the same direction as a motion vector of a forward reference block with respect to the anchor block, as a predictive motion vector, performing motion compensation by using the predictive motion vector, and setting a prediction mode as a forward temporal extended skip mode when the motion compensation results in satisfaction of an optimal skip condition; and
an encoder for encoding the prediction mode.

3. The apparatus of claim 2, wherein the block in the backward reference picture is a block in a reference picture that is closest to the current block among all other backward reference pictures.

4. The apparatus of claim 2, wherein the optimal skip condition is determined to be satisfied when a rate-distortion cost of the forward temporal extended skip mode is small in consideration of a distortion value and a bit amount that are generated when predicting and encoding a current block for each of inter-prediction mode candidates in all inter-predictable mode sets including the forward temporal extended skip mode.

5. An apparatus for encoding an image, comprising:
a mode determiner for referring to an anchor block representing a block located in a backward reference picture at the same position as a current block, setting a backward reference block motion vector in the opposite direction to a forward reference block motion vector with respect to the anchor block, as a predictive motion vector, performing motion compensation by using the predictive motion vector, and setting a prediction mode as a backward temporal extended skip mode when the motion compensation results in satisfaction of an optimal skip condition; and
an encoder for encoding the prediction mode.

6. The apparatus of claim 5, wherein the block in the backward reference picture is a block in a reference picture that is closest to the current block among all other backward reference pictures.

7. The apparatus of claim 5, wherein the optimal skip condition is determined to be satisfied when a rate-distortion cost of the backward temporal extended skip mode is small in consideration of a distortion value and a bit amount that are generated when predicting and encoding a current block for each of inter-prediction mode candidates in all inter-predictable mode sets including the backward temporal extended skip mode.

8. An apparatus for encoding an image, comprising:
a mode determiner for determining a predictive motion vector of a current block from a backward reference block motion vector with respect to one or more adjacent blocks of the current block, performing motion compensation by using the predictive motion vector, and setting a prediction mode as a backward spatial extended skip mode when the motion compensation results in satisfaction of an optimal skip condition; and
an encoder for encoding the prediction mode.

9. The apparatus of claim 8, wherein the optimal skip condition is determined to be satisfied when a rate-distortion cost of the backward spatial extended skip mode is small in consideration of a distortion value and a bit amount that are generated when predicting and encoding a current block for each of inter-prediction mode candidates in all inter-predictable mode sets including the backward spatial extended skip mode.

10. The apparatus of claim 8, wherein the backward reference block motion vector is set as a median of backward reference block motion vectors of the one or more adjacent blocks of the current block.

11. An apparatus for decoding an image, comprising:
a decoder for decoding a prediction mode by decoding encoded data; and
a predictor, responsive if the prediction mode is a forward temporal extended skip mode, for generating a predicted block by predicting a current block by referring to an anchor block representing a block located in a backward reference picture at the same position as a current block and using a forward reference block motion vector in the same direction as a motion vector of a forward reference block with respect to the anchor block.

12. The apparatus of claim 11, wherein the block in the backward reference picture is a block in a reference picture that is closest to the current block among all other backward reference pictures.

13. An apparatus for decoding an image, comprising:
a decoder for decoding a prediction mode by decoding encoded data; and
a predictor, responsive if the prediction mode is a backward temporal extended skip mode, for generating a predicted block by predicting a current block by using a backward reference block motion vector in the opposite direction to a forward reference block motion vector with respect to a block located in a backward reference picture at the same position as the current block.

14. The apparatus of claim 13, wherein the block in the backward reference picture is a block in a reference picture that is closest to the current block among all other backward reference pictures.

15. An apparatus for decoding an image, comprising:
a decoder for decoding a prediction mode by decoding encoded data; and
a predictor for generating a predicted block by predicting a current block by using a motion vector of a backward reference block with respect to one or more adjacent blocks of the current block when the prediction mode is a backward spatial extended skip mode.

16. The apparatus of claim 15, wherein the backward reference block motion vector is set as a median of backward reference block motion vectors of the one or more adjacent blocks of the current block.

17-26. (canceled)

27. A method for decoding an image, comprising:
decoding a prediction mode by decoding encoded data; and
if the prediction mode is a forward temporal extended skip mode, generating a predicted block by predicting a current block by referring to an anchor block representing a block located in a backward reference picture at the same position as a current block and using a forward reference block motion vector in the same direction as a motion vector of a forward reference block with respect to the anchor block.

28. The method of claim 27, wherein the block in the backward reference picture is a block in a reference picture that is closest to the current block among all other backward reference pictures.

29. A method for decoding an image, comprising:
decoding a prediction mode by decoding encoded data; and
if the prediction mode is a backward temporal extended skip mode, generating a predicted block by predicting a current block by referring to an anchor block representing a block located in a backward reference picture at the same position as a current block and using a backward reference block motion vector in the opposite direction to a motion vector of a forward reference block with respect to the anchor block.

30. The method of claim 29, wherein the block in the backward reference picture is a block in a reference picture that is closest to the current block among all other backward reference pictures.

31. A method for decoding an image, comprising:
decoding a prediction mode by decoding encoded data; and
generating a predicted block by predicting a current block by using a motion vector of a backward reference block with respect to one or more adjacent blocks of the current block when the prediction mode is a backward spatial extended skip mode.

32. The method of claim 31, wherein the backward reference block motion vector is set as a median of backward reference block motion vectors of the one or more adjacent blocks of the current block.
